(19) United States
(12) Patent Application Publication
(10) Pub. No.: US 2015/0376410 A1
(43) Pub. Date: Dec. 31, 2015

(54) CATIONIC ASPHALT EMULSION FOR PRIME COAT

(71) Applicant: Praphot ISSARIYAKUL, (US)

(72) Inventor: Praphot ISSARIYAKUL, Bangkok (TH)

(21) Appl. No.: 14/766,242

(22) PCT Filed: Feb. 7, 2014
(86) PCT No.: PCT/TH2014/000004

§ 371 Date: Aug. 6, 2015

(30) Foreign Application Priority Data
Feb. 8, 2013 (TH) 1301000689

(51) Int. Cl. C08L 95/00; C09D 195/00; C09K 3/22

(52) U.S. Cl. CPC C08L 95/005; C09K 3/22; C09D 195/005; C08L 2555/24; C08L 2555/22

(57) ABSTRACT

A cationic asphalt emulsion for prime coat according to this invention can be used as prime coat for road base course—both untreated base course and treated base course. Once the asphalts dry, they will securely adhere to the base course. It's convenient to use since no need to heat asphalt emulsion while using. The viscosity can be altered by adding the water, so no fire hazardous during heating. The traffic can be back to normal without spreading sand. Besides, the cost is much lower compared to the cutback asphalts, and also less volatile hydrocarbon solvent emissions into the atmosphere. Other than road construction, it can also be applied in other applications, such as temporary covering road in the mine or road under construction, covering open space to reduce airborne dust generated by wind, and covering ground under the building to prevent termite entry into the building, etc.

### FIELD OF THE INVENTION

This invention relates to a cationic asphalt emulsion for prime coat for road construction in order to improve concealment of base course with no paving of any kind before; to prevent surface peelings, dust spreading, water penetration through the base course; and also act as a binder to enhance adhesion between base course layer and subsequent paving surface layer.

### BACKGROUND OF THE INVENTION

Road constuction includes a step of compacting road base course firmly and uniformly for the next step (i.e. paving). At this stage, the asphalts sprayed to conceal the base course are generally known as prime coat. The benefits of prime coat are to enhance aggregate's cohesion of road base course resulting in no surface damage prior to paving, to prevent dust spreading from road usage while no paving, to prevent water penetration through the base course prior to paving, and to act as a binder to enhance adhesion between the base course layer and the subsequent paving surface layer. This technique is commonly used as worldwide standard by applying these two types of asphalt.

1. Cutback asphalt—it is an asphalt that has been liquefied by adding hydrocarbon solvent oil to dilute asphalt. Type and percentage of hydrocarbon solvent oil depend on the application. There are several types of cutback asphalt, such as rapid cure, medium cure, and slow cure. The most extensive use is medium curing type, in particular MC30 or MC70 cutback asphalt. The benefits of these cutback asphalts are able to penetrate through dust layer adhering to the base course, and also penetrate through small pores so as to enhance cohesion between aggregates. Still, the drawback of cutback asphalts is excessive amount of hydrocarbon solvent (approx. 35%-40%) resulting in slow dry (i.e. at least one week before paving the base course). The evaporation of high amount of hydrocarbon solvent leads to environmental pollution. Besides, it is hazardous for the workers because the cutback asphalt is simply flammable while heating the cutback asphalts to reduce viscosity suitable for spraying. Many countries have banned the cutback asphalts. Moreover, the operation cost is high owing to high hydrocarbon solvent cost.

2. Asphalt emulsion—since the production of asphalt emulsion requires emulsifiers to disperse asphalts in the water, hence; the type of emulsifier determines the type of asphalt emulsion, i.e. cationic, anionic, or non-ionic types. Since the cationic asphalt emulsions have a better chemical reaction with common aggregates than the anionic and non-ionic asphalt emulsions. Water can be expelled from aggegate's surface resulting in asphalt drying faster as stated in the document of Caltrans: Division of Maintenance: October 2003, page 18. Consequently, the cationic asphalt emulsions are most commonly used. For prime coat applications, since the chemical and asphalt emulsion manufacturers over the world have understood that as long as the asphalts can maintain colloid state, the asphalt emulsions are likely to penetrate to the base course through small pores between aggregates. Worldwide standard specifies to use slow setting asphalt emulsions, i.e. allowing a minimum or no reaction between the asphalt emulsions and aggregates. As noted previously, the cationic asphalt emulsion is most commonly used, mainly slow setting cationic asphalt emulsions (CSS-1) for prime coat application.

However, all users will experience the same problem, which is that asphalt can peel easily (i.e. no adhesion to the base course) even if supporting by standards, e.g. ASTM D2397, BS 434, etc. As few vehicles passing, the surfaces begin to peel. So, the contractor usually spreads sand over the surface, for example, a recommendation in the Report No. FHWA/TX-10/0-5635-1, Title: Effective Prime Coats for Compacted Pavement, Published: August 2010, page 8: Inverted Prime or Covered Prime. Although, this is effective, but it costs more, and diminishes a core function of prime coat (i.e. a binder between base course and road surface) because of sand blocking between the prime coat and pavement. Moreover, the spreaded sand will absorb the asphalt causing loss of asphalts. Although, the size of asphalt through the grinding mill and suspended in the water having size of 10-100 microns, it is still impossible for the asphalt particles to pass through the pores. This is because the size of pores is less than 1 micron. So, each manufacturer adds the oil or other additives to reduce the viscosity of the asphalt, and also adding large amount of water (expecting for better penetration). As a result, the asphalt emulsions contains only 5-15% asphat, hence; several times of asphalt emulsion spraying are required to achieve enough asphalt for base course coverage.

Furthermore, numbers of articles from the US national agencies are provided as additional references.

Central Federal Lands Highway (CFLH), which is an agency within the US Department of Transportation, states in the Guidelines for Using Prime and Tack Coats, Publication No. FHWA-CFL/TD-05-002, July 2005, page 69 that the prime should not be applied to stabilized bases of subgrade. Also in page 83, it reveals that the regular asphalt emulsions (i.e. asphalt emulsions according to ASTM standard having SS-1 asphalt emulsion, CSS-1 asphalt emulsion, etc.) are not suitable for use as prime coat because they do not penetrate through the surface unless diluted with water. Bases with a high percentage of fine grained materials do not allow emulsified asphalt particles penetrate. Scarfication of the surface to a depth of 25 to 50 mm is recommended to produce penetrable asphalt emulsions.

Texas Department of Transportation stated in the Construction Division, October 2006, page 9, reveals that the SS-1, SS-1H, CSS-1, and CSS-1H asphalt emulsions can be used as prime coat. Since these asphalt emulsions cannot penetrate through the surface, hence; it must be premixed with the base by scarifying the surface to a depth of 25 mm, then adding asphalt emulsion, mixing together, and then recompacting.

Asphalt Emulsion Manufacturers Association (AEMA) specifies on the website under the title “Tack coat and prime coat application with asphalt emulsion asphalt” that the slow-setting grades of asphalt emulsions (diluted with water before application) are suitable for use as prime coat in USA. With dense bases or stabilized bases, the surface may need to be scarified before application, to ensure good penetration.

Asphalt Emulsion Manufacturers Association (AEMA) specified in the Performance Guidelines, Asphalt Emulsion Prime (AEP), March 2004, chapter 10, section 10.6.4 states that the application of sand cover is often applied to allow traffic for some interim use period.

In conclusion, all these agencies indicated that a proper material for prime coat excluding cutback asphalt is the slow-setting grades of asphalt emulsions. But the asphalt emulsions do not penetrate through the surface even if it is an untreated base. Hence, these agencies do not recommend these asphalt emulsions for treated base. Still, the prime coat is essential, therefore; when the asphalt emulsions are used as prime coat, any or all together of the followings is applied with reference to condition of the surface of road base course.

1. Scarifying the surface to a depth of 25 to 50 mm to break up the surface allowing the penetration of asphalt emulsions.

2. Mixing asphalt emulsion and water to dilute asphalt and reduce the viscosity of asphalt emulsion facilitating penetration.

3. Spreading sand over the surface to prevent the asphalt picked up by vehicle's tires. This is because the asphalt emulsions typically do not penetrate. As the asphalt emulsions dry, they won't affix to the surface, but will stick to the wheel.

The cationic asphalt emulsion for prime coat in this invention can address all above drawbacks. This will be explained in more details as follows.

### SUMMARY OF THE INVENTION

The objectives of this invention intend to address all above drawbacks as follows:

1. Can spray the cationic asphalt emulsion for prime coat of this invention on the base course without scarifying the surface of the base course.

2. Can apply the cationic asphalt emulsion for prime coat of this invention directly without any water dilution, where having 35-45% asphalt.

3. Can allow the traffic back to normal without spreading sand after allowing the cationic asphalt emulsion for prime coat of this invention to dry within 24 hours. This is because the asphalts securely adhere to the base course with no peeling.

This invention relates to the cationic asphalt emulsion composition for prime coat comprising asphalt, aliphatic diamine emulsifiers, hydrocarbon solvents, acids, and water. The cationic asphalt emulsion composition for prime coat according to this invention can be used as prime coat for road base course—both untreated base course and treated base course. Once the asphalts dry, they will securely adhere to the base course. It's convenient to use since no need to heat asphalt emulsion while using. The viscosity can be altered by adding water, so no danger of fire for heating. The traffic can be back to normal without spreading sand. Besides, the cost is much lower compared to the cutback asphalts, and also less volatile hydrocarbon solvent emissions into the atmosphere.

This invention provides the cationic asphalt emulsion composition for prime coat, which the inventor has improved for better according to this invention. It can penetrate through the dust layer covering the base course in order to allow broken asphalts adhering to compacted base course with no peeling once the traffic back to normal.

The cationic asphalt emulsion for prime coat according to this invention has superior properties to all current existing asphalt emulsions, i.e. cationic, anionic, and non-ionic types. Besides, this invention can penetrate through the base course similar to the cutback asphalts, but having other numerous properties greater than the cutback asphalts.

The advantages of the cationic asphalt emulsion for prime coat according to this invention compared to the properties of cutback asphalt are:

(a) The cationic asphalt emulsion according to this invention is safer because this asphalt emulsion is non-flammable.

(b) The cationic asphalt emulsion according to this invention can be used at normal temperature 20-60° C. without heating to adjust the viscosity. The water can be added once the viscosity adjustment needed.

(c) The cationic asphalt emulsion according to this invention reduces environmental pollution by lessening 30-60% hydrocarbon solvents usage depending on the base course. For the untreated base course having wide pores, the hydrocarbon solvent reduces by about 60%. While the treated base course having very small pores, the hydrocarbon solvent reduces by about 30%.

(d) The cationic asphalt emulsion according to this invention can allow the traffic back to normal faster, within 12-36 hours, depending on weather conditions. While the cutback asphalts take 3-7 days.

(e) The cationic asphalt emulsion according to this invention can reduce manufacturing costs by 30-50% due to a decrease in amount of hydrocarbon solvent.

The asphalt emulsion according to the invention can also be sprayed to cover temporary road surface, e.g. road in mine or spraying over the area under construction, or covering open space to reduce airborne dust generated by wind, and covering ground under the building to prevent termite entry into the building. This invention includes a method of producing asphalt emulsion provided asphalt emulsion having required quality, and also how to use such asphalt emulsion.

### BRIEF DESCRIPTION OF THE DRAWINGS

FIG. 1 shows results of Experiment 1, which is a penetration experiment in the laboratory where;

FIGS. 1.1, 1.2 and 1.3 show CSS-1 asphalt emulsion, asphalt emulsion according to this invention, and cutback asphalt, respectively, while recently poured each type of asphalts has not yet penetrated into the Portland cement layer.

FIG. 1.4 shows, after 24 hours, most water from CSS-1 asphalt emulsion separated and penetrated into the Portland cement type 1 leading to a decrease in asphalt emulsion height. But, the asphalts cannot penetrate into the Portland cement at all, thus; only smooth and glossy surface of asphalts coverage appears.

FIG. 1.5 shows, after 3 hours, the asphalt emulsion according to the invention penetrated completely into the Portland cement type 1, showing texture of the Portland cement surface. They can penetrate into the Portland cement layer to a depth of approximately 10 mm.

FIG. 1.6 shows, after 1 hour, the cutback asphalt penetrated completely into the Portland cement type 1, showing texture of the Portland cement surface. They can penetrate into the Portland cement layer to a depth of approximately 12 mm.

FIG. 2 shows results of Experiment 2, which is a penetration experiment on the actual road base course where,

FIG. 2.1 shows CTB (cement treated base) course that has not been sprayed with any types of asphalt. The micro textures of surface are detectable whereas pores are difficult to detect due to highly compacted surface.

FIG. 2.2 shows the CTB course sprayed with the CSS-1 asphalt emulsion. The asphalt emulsion cannot penetrate through the dust layer, i.e. simply floating on top of the dust layer on the base course. After 24 hours, the asphalt emulsion dried. The asphalts remained on the surface, hence; the micro textures are undetectable. Only macro textures are detectable.

FIG. 2.3 shows the CTB course sprayed with the cationic asphalt emulsion for prime coat according to this invention. The asphalt emulsion can penetrate through the dust layer. After 24 hours, the asphalt emulsion dried, so the micro textures appeared clearly.

FIG. 2.4 shows the CTB course sprayed with the cutback asphalt. The asphalt can penetrate through the dust layer. After 24 hours, the cutback asphalt dried, so the micro textures appeared clearly.

FIG. 3 shows results of Experiment 3, which is an adhesion experiment of the asphalts on the actual base course where,

FIG. 3.1 shows CSS-1 asphalt emulsion sprayed on the base course. After 24 hours, allowing car run over 20 times, it revealed that the asphalt peeled off approximately 20% of base course area. This is because the asphalt did not adhere to the surface of base course.

FIG. 3.2 shows the asphalt emulsion according to this invention sprayed on the base course. After 24 hours, allowing car run over 20 times, it revealed that 100% of asphalt adhered securely to the base course, i.e. no peeling occurrence.

### DETAILED DESCRIPTION OF THE EMBODIMENTS

An embodiment of this invention is a cationic asphalt emulsion composition for prime coat according to this invention comprising

| | | |
|---|---|---|
| asphalt | 20%-60% | wt |
| aliphatic diamine emulsifier | 0.1%-0.6% | wt |
| hydrocarbon solvent | 5%-20% | wt |
| acid | 0.1%-1.5% | wt |
| water | 20%-75% | wt |

Another embodiment of this invention is a cationic asphalt emulsion composition for prime coat, which is suitable to apply without additional water. This comprises

| | | |
|---|---|---|
| asphalt | 35%-50% | wt |
| emulsifier | 0.12%-0.4% | wt |
| hydrocarbon solvent | 10%-16% | wt |
| acid | 0.1%-0.4% | wt |
| water | 34%-55% | wt |

The asphalts used according to the invention should have appropriate hardness (measured in penetration unit) for saving the added hydrocarbon solvent. Such asphalts should have hardness value (measured in penetration unit) in a range of 30-250, preferably and commercially available of 60-100.

Any suitable types of aliphatic diamine emulsifiers can be applied in the production according to this invention. The aliphatic diamine emulsifiers may be selected from the group represented by formula I and/or II, as follows:

R₁—NH—R₂—NH₂ (I) and/or

R₁—NH—R₃—NH₂ (II)

in which:

R₁ is an aliphatic, saturated or unsaturated, linear or branched grouping having 8 to 30 carbon atoms;

R₂ is an aliphatic, saturated or unsaturated, linear or branched grouping having 1 to 6 carbon atoms;

R₃ is an aliphatic, saturated or unsaturated, linear or branched grouping having 1 to 6 carbon atoms, at least one of these carbon atoms being substituted by hydroxyl group.

The emulsifiers according to this invention may be a single emulsifier selected from the emulsifiers, which replaced by formula I, formula II, a mixture of formula I and II. Besides, a co-emulsifier may be applied to improve specific characteristics of the asphalt emulsions, or to facilitate the preparation of emulsifier solution. One of suitable aliphatic diamines for formula I is N-[(9Z)-octadec-9-en-1-yl]propane-1,3-diamine where another suitable aliphatic diamines for formula II is di(2-hydroxypropyl)tallow amine.

A preferred hydrocarbon solvent according to the invention is a light hydrocarbon solvent having low boiling point. To expedite the dryness of asphalt emulsions on the base course, the final boiling point should be lower than 250° C. However, hydrocarbon solvent having boiling point higher or lower than this can be applied depending on the requirement. The cationic asphalt emulsion composition for prime coat according to this invention may use other solvents or oils instead of the hydrocarbon solvent. Such solvents or oils have physical properties, which can dissolve the asphalts.

The cationic asphalt emulsion composition for prime coat according to this invention should contain at least 5% to 10% of hydrocarbon solvent by weight compared to total amount of asphalt emulsion by weight.

The acids according to this invention are generally used hydrochloric acid (HCl) due to low cost, availability, and well-reacted. However, in case of necessity, or not able to acquire hydrochloric acid, or having other special purposes, other acids may be applied, such as phosphoric acid (H₃PO₄) or other acids as appropriate.

The water according to this invention is clean water with low amount of colloids, clear, drinkable, and having pH 7±1.

The cationic asphalt emulsion composition for prime coat according to this invention preferably has the asphalt of 65%-85% wt, and the hydrocarbon solvent of 15%-35% wt. Thus, the total amount of the asphalt and hydrocarbon solvent is 100%.

A purpose of this invention is to provide a batch type method of manufacturing the cationic asphalt emulsion for prime coat comprises following steps.
(a) Heating the asphalt at 110-180° C. to reduce viscosity of asphalt
(b) Filling the hydrocarbon solvent into the asphalt and mixing homogeneously to feed into the mill
(c) Preparing aqueous solution by adding the acid into the water providing state of being acid. This is because the emulsifier dissolves well in water having acidity state. Then, the emulsifier is adding into a mixture of water and acid, stirring until well-dissolved.
(d) Feeding both mixtures into a mill simultaneously

Once all mixtures pass through the mill becomes homogeneous providing the cationic asphalt emulsions for prime coat. The obtained product from such method is the composition of cationic asphalt emulsion for prime coat according to this invention.

A purpose of this invention is to provide a continuous method of manufacturing the cationic asphalt emulsion for prime coat comprises following steps.
(a) Heating the asphalt at 110-180° C. to reduce viscosity of asphalt
(b) Feeding the hydrocarbon solvent and the asphalt into static mixer before feeding into the mill
(c) Feeding water, acid, and emulsifier via another pipeline to gather all these liquid to feed into the mill
(d) Feeding both mixtures (b) and (c) into a mill simultaneously

Once all mixtures pass through the mill becomes homogeneous providing the cationic asphalt emulsions for prime coat. The obtained product from such method is the composition of cationic asphalt emulsion for prime coat according to this invention.

Another purpose of this invention is to provide the cationic asphalt emulsion for prime coat having characteristics according to standard ASTM D244 as follows:

| | |
|---|---|
| Viscosity, Saybolt Furol at 25° C. SFS | 15-100 |
| Storage stability test, 24 hour, % wt | ≦5 |
| Demulsibility, 35 mL, 0.8% dioctyl sodium | ≦15 |
| Sulfosuccinate, % wt | |
| Cement mixing test, % wt | ≧10 |
| Seive test, % wt | ≦0.1 |
| Particle charge test | positive |
| Oil distillate, by volume of emulsion, % | ≧5 |
| Emulsion Distillation, residue, % wt | ≧20 |

Applying the cationic asphalt emulsion for prime coat according to this invention to different road base courses may require adjusting the characteristics of the cationic asphalt emulsion for prime coat according to this invention to suit the porosity of the surface and the inner layers of the road base course. The road base courses are divided into two groups.

1. Untreated Base Course

An untreated base course is the road base course used only aggregates. This type of base course has high porosity. The asphalt emulsions can penetrate to a depth of 10-20 mm, so the use rate of asphalt emulsions is in a high range of 1.2 to 2.5 kg/m². This is to provide a thick sprayed film and enough asphalt to deeply penetrate where the asphalt emulsions do not flow outside the base course. The asphalt emulsions have relatively high viscosity, i.e. the viscosity, Saybolt Furol at 25° C., about 25-50 SFS. And, due to high porosity, low amount of hydrocarbon solvent, i.e. 15-20%, can be applied to 80-85% asphalt (A combination of the hydrocarbon solvent and the asphalt equals to 100%). In some cases, the contractors apply fine dust over and slush rolling. These pores are covered by fine dust resulting in no porosity at the surface. This reduces penetration of asphalt emulsion, i.e. may be only 1-3 mm. Although this method is not right, but there are many contractors applied this. In this case, the use rate of asphalt emulsion may be reduced to 0.6-1.2 kg/m². Hence, the viscosity, Saybolt Furol at 25° C., is reduced to 15-25 SFS to obtain thin sprayed film, no excess asphalt on the surface.

2. Treated Base Course

The treated base course is conducted by applying additives (e.g. Portland cement, emulsified asphalts, etc.) or other techniques (e.g. cold in place recycling). The latter base courses have low porosity, in case of adding 3.5%-4% Portland cement into the cement treated base. Since Portland cement is fine (having size close to dust) when penetrate through pores resulting to a decrease in size and number of pores. Thus, the asphalt emulsions penetrate to a depth of only 1-3 mm. In this case, the use rate of asphalt emulsions is low (i.e. 0.6-1.2 kg/m²), which is sufficient to cover surface of base course. So, the used asphalt emulsions have relatively low viscosity, i.e. the viscosity, Saybolt Furol at 25° C., about 15-25 SFS to obtain thin sprayed film, no excess asphalt on the surface. And, due to low porosity, high amount of hydrocarbon solvent, i.e. 20-25%, can be applied to 75-80% asphalt (A combination of the hydrocarbon solvent with the asphalt equals to 100%). Providing the asphalt emulsion according to this invention can penetrate through small pore size.

A use of the cationic asphalt emulsion composition for prime coat according to this invention is preferably to spray such asphalt emulsion on the road base course at a rate of 0.6-2.5 l/m² depending on the porosity of the base course.

Also, the use of the cationic asphalt emulsion composition for prime coat according to this invention is spraying the asphalt emulsions over the temporary road, such as roads in the mine, or temporary roads under construction to reduce airborne dust, can be sprayed off the surface of open space to reduce airborne dust generated by wind.

It is also possible to use such asphalt emulsions sprayed over the ground under the building to prevent termites' entry from under-building into the house using high rate of 2.0-10.0 kg/m².

Applying the cationic asphalt emulsion for prime coat according to this invention to spray on the base course requires a clean surface. No loosen aggregates or leaf or waste or thick dust remains on the surface before spraying the cationic asphalt emulsion for prime coat, then spraying water to moisten the surface (but no excess water). The cationic asphalt emulsion for prime coat is sprayed on the base course, closed the traffic until dry. This takes about 12-36 hours depending on the weather and the surface of the base course. The traffic can be back to normal, but the speed has to be controlled.

### EXAMPLE

The followings are examples of testing to verify properties of the cationic asphalt emulsions for prime coat according to this invention where the inventor conducted three experiments.

Experiment 1 laboratory testing to investigate the penetration through the dust layer of various types of asphalt.

The penetration through the dust layer of CSS-1 asphalt emulsion, asphalt emulsion according to this invention, and cutback asphalt was tested using the Portland cement type 1 representing dust. 100 g of the Portland cement was filled into the test tube with diameter43 mm achieving the thickness of about 40 mm, and then poured 10 g of each asphalt types into the test tube over the Portland cement surface, waited until the Portland cement surface being visible again, and recorded the penetration time.

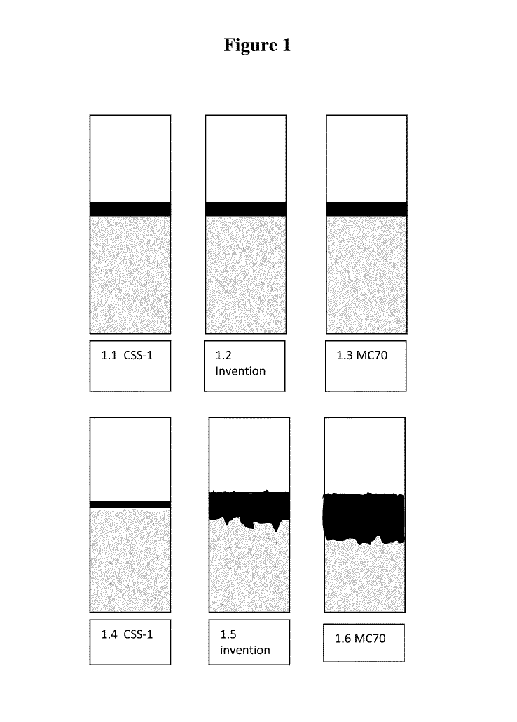

FIGS. 1.1, 1.2 and 1.3 show CSS-1 asphalt emulsion, asphalt emulsion according to this invention, and cutback asphalt, respectively, while recently poured each type of asphalts has not yet penetrated into the Portland cement layer.

FIG. 1.4 shows, after 24 hours, most water from CSS-1 asphalt emulsion separated and penetrated into the Portland cement leading to a decrease in asphalt emulsion height. But, the asphalts could not penetrate into the Portland cement at all, thus; only smooth and glossy surface of asphalts coverage appeared.

FIG. 1.5 shows, after 3 hours, the asphalt emulsion according to the invention penetrated completely into the Portland cement, showing texture of the Portland cement surface. They could penetrate into the Portland cement layer to a depth of about 10 mm.

FIG. 1.6 shows, after 1 hour, the cutback asphalt penetrated completely into the Portland cement, showing texture of the Portland cement surface. They could penetrate into the Portland cement layer to a depth of about 12 mm.

Experiment 2 actual road testing to compare the penetration for each type of asphalts on the cement treated base course, which is the most difficult course for penetrating.

To observe the penetration through the dust layer of the treated base course where the tested base course was the cement treated base (CTB) with 3.5% Portland cement in aggregates. It was cured for 2 weeks. The test was conducted by spraying each type of asphalts with the rate of 1.0 kg/m² over the base course, left for 24 hours, and then took the photos for comparison.

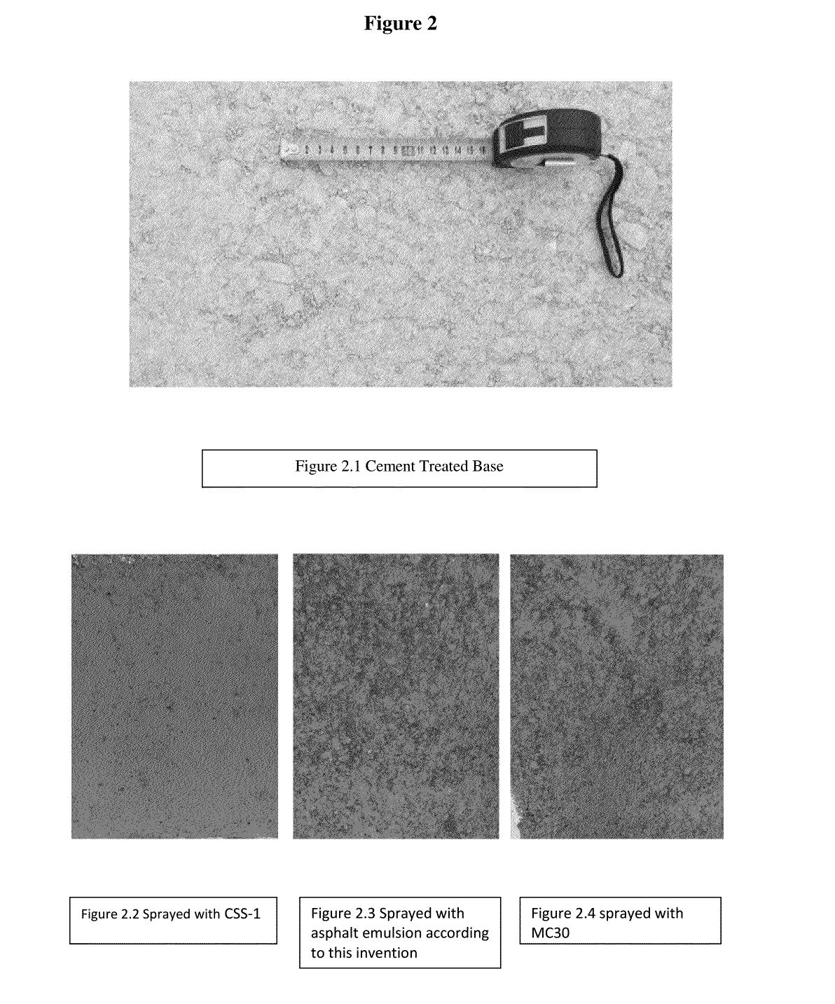

FIG. 2.1 shows CTB course that was not sprayed with any types of asphalt. The micro textures of surface were detectable whereas pores were difficult to detect due to highly compacted surface.

FIG. 2.2 shows the course sprayed with the CSS-1 asphalt emulsions. The asphalt emulsions couldnot penetrate through the dust layer, i.e. simply floating on top of the dust layer on the base course. After 24 hours, the asphalt emulsion dried. The asphalts remained on the surface, hence; the micro textures were undetectable. Only macro textures were detectable.

FIG. 2.3 shows the course sprayed with the cationic asphalt emulsion for prime coat. The asphalt emulsion can penetrate through the dust layer. After 24 hours, the asphalt emulsion dried and well penetrated, so the micro textures appeared clearly.

FIG. 2.4 shows the course sprayed with the cutback asphalt. The asphalts can penetrate through the dust layer. After 24 hours, the cutback asphalts dried and well penetrated, so the micro textures appeared clearly.

Experiment 3 actual base course testing to compare the adhesion of the asphalts to the untreated base course allowing the traffic, and investigating the asphalt's peeling.

The adhesion of the asphalt with the untreated road base course was tested by spraying the CSS-1 asphalt emulsion and the cationic asphalt emulsion for prime coat over the base course, which used aggregates according to standard ASTM D1241 of aggregate type C size. Each test section size 1.0×1.0 meters, asphalt applied rate was 1.2 kg/m², left for 24 hours and then run over by 1 ton pickup 20 times, then investigated the peeling of asphalts.

After sprayed by both types of asphalt emulsions, left for 24 hours, and then run over by 1 ton pickup 20 times, the results of asphalt surface inspection showed.

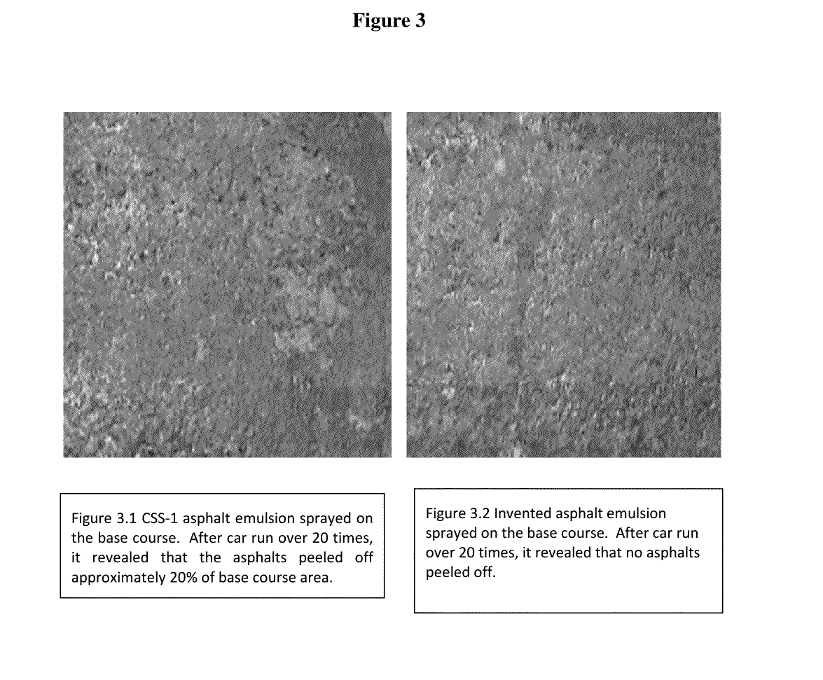

FIG. 3.1 shows that the CSS-1 asphalt emulsion peeled off approximately 20% of base course area. This was because the broken asphalt did not adhere to the surface of base course.

FIG. 3.2 shows that 100% of the asphalt emulsions according to this invention still adhered securely, i.e. no peeling occurrence.

The main reason that commonly used CSS-1 asphalt emulsion did not adhere with the base course. Although, the CSS-1 asphalt emulsion is the most stable among all cationic asphalt emulsions, but the CSS-1 asphalt emulsion instantly breaks when contacting the dust on the base course, generating asphalt film on the dust. Thus, the rest of asphalt emulsions could not penetrate through the broken asphalts becoming the film blocked further penetration of asphalt emulsions. As the asphalt emulsions dried, the obtained asphalts left on the dust, was easy to peel off when having traffic.

The invention to develop new asphalt emulsion formula for prime coat is useful for road construction. This is because the new asphalt emulsion formula according to this invention can be applied instantly without heating, mixing with water to reduce the viscosity of asphalt emulsion. In case of applying the asphalt emulsion to the treated bases, the viscosity of asphalt emulsion according to this invention may be reduced by adding little water, having 35%-45% asphalts while using. So, by spraying the asphalt emulsion one time provides sufficient asphalt, no need to repeat, indicating less cost and time consuming. The most essential issue is capability to penetrate through the dust layer covered the surface of the base course deep into the compacted base course. The penetration depth into the base course depends on the size and number of pore.

This complete disclosure reveals an alternative method of manufacturing or various ways of use. These descriptions do not limit the scope and purpose of the invention as defined in the claims at all. Therefore, it considers that the complete invention disclosure as defined above is just an example for understanding, but not limited to claim.

What is claimed is:

1. A cationic asphalt emulsion composition for prime coat comprising:

| | | |
|---|---|---|
| (a) asphalt | 20%-60% | wt |
| (b) aliphatic diamines emulsifier | 0.1%-0.6% | wt |
| (c) hydrocarbon solvent | 5%-20% | wt |
| (d) acid | 0.1%-1.5% | wt |
| water add to 100% | | |

2. The cationic asphalt emulsion composition for prime coat of claim 1, wherein said emulsifier is aliphatic diamines selected from the group consisting of formula I and/or II:
R₁—NH—R₂—NH₂ (I) and/or
R₁—NH—R₃—NH₂ (II)
in which:
R₁ is an aliphatic, saturated or unsaturated, linear or branched grouping having 8 to 30 carbon atoms;
R₂ is an aliphatic, saturated or unsaturated, linear or branched grouping having 1 to 6 carbon atoms;
R₃ is an aliphatic, saturated or unsaturated, linear or branched grouping having 1 to 6 carbon atoms, at least one hydroxyl group attached to a carbon atom.

3. The cationic asphalt emulsion composition for prime coat of claim 1, wherein said aliphatic diamine emulsifiers are single emulsifier selected from the emulsifiers, which replaced by formula I, formula II, a mixture of formula I and II. Besides, a co-emulsifier is applied to improve specific characteristics of the asphalt emulsions, or to facilitate the preparation of emulsifier solvent.

4. The cationic asphalt emulsion composition for prime coat of claim 1, wherein one of preferred aliphatic diamine for formula I is N-[(9Z)-octadec-9-en-1-yl]propane-1,3-diamine.

5. The cationic asphalt emulsion composition for prime coat of claim 1, wherein one of preferred aliphatic diamine for formula II is di(2-hydroxypropyl)tallow amine.

6. The cationic asphalt emulsion composition for prime coat of claim 1, wherein such hydrocarbon solvent is preferably a light hydrocarbon solvent having low boiling point, having final boiling point lower than 250° C.

7. The cationic asphalt emulsion composition for prime coat of claim 1, wherein the hydrocarbon solvent is replaced by other solvents or oils that can dissolve the asphalts.

8. The cationic asphalt emulsion composition for prime coat of claim 1, wherein an amount by weight of the hydrocarbon solvent compared to total amount of asphalt emulsion is at least 5%.

9. The cationic asphalt emulsion composition for prime coat of claim 1, wherein the preferred acid is hydrochloric acid or other types of acid.

10. The cationic asphalt emulsion composition for prime coat of claim 9, wherein the other types of acid are preferably phosphoric acid (H₃PO₄).

11. A cationic asphalt emulsion composition for prime coat, which is suitable to apply without additional water comprising:

| | | |
|---|---|---|
| (a) asphalt | 35%-50% | wt |
| (b) aliphatic diamines emulsifier | 0.12%-0.4% | wt |
| (c) hydrocarbon solvent | 10%-16% | wt |
| (d) acid | 0.1%-0.4% | wt |
| water add to 100% | | |

12. The cationic asphalt emulsion composition for prime coat of claim 11, wherein said emulsifier is aliphatic diamines selected from the group consisting of formula I and/or II:
R₁—NH—R₂—NH₂ (I) and/or
R₁—NH—R₃—NH₂ (II)
in which:
R₁ is an aliphatic, saturated or unsaturated, linear or branched grouping having 8 to 30 carbon atoms;
R₂ is an aliphatic, saturated or unsaturated, linear or branched grouping having 1 to 6 carbon atoms;
R₃ is an aliphatic, saturated or unsaturated, linear or branched grouping having 1 to 6 carbon atoms, at least one hydroxyl group attached to a carbon atom.

13. The cationic asphalt emulsion composition for prime coat of claim 11, wherein said aliphatic diamine emulsifiers are single emulsifier selected from the emulsifiers, which replaced by formula I, formula II, a mixture of formula I and II. Besides, a co-emulsifier is applied to improve specific characteristics of the asphalt emulsions, or to facilitate the preparation of emulsifier solution.

14. The cationic asphalt emulsion composition for prime coat of claim 11, wherein one of preferred aliphatic diamine for formula I is N-[(9Z)-octadec-9-en-1-yl]propane-1,3-diamine.

15. The cationic asphalt emulsion composition for prime coat of claim 11, wherein one of preferred aliphatic diamine for formula II is di(2-hydroxypropyl)tallow amine.

16. The cationic asphalt emulsion composition for prime coat of claim 11, wherein such hydrocarbon solvent is preferably a light hydrocarbon solvent having low boiling point, having final boiling point lower than 250° C.

17. The cationic asphalt emulsion composition for prime coat of claim 11, wherein the hydrocarbon solvent is replaced by other solvents or oils that can dissolve the asphalts.

18. The cationic asphalt emulsion composition for prime coat of claim 11, wherein an amount by weight of the hydrocarbon solvent compared to total amount of asphalt emulsion is at least 10%.

19. The cationic asphalt emulsion composition for prime coat of claim 11, wherein the preferred acid is hydrochloric acid or other types of acid.

20. The cationic asphalt emulsion composition for prime coat of claim 19, wherein the other types of acid are preferably phosphoric acid (H₃PO₄).

21. The cationic asphalt emulsion composition for prime coat of claim 1, wherein the asphalt is preferably in a range of 65%-85% wt, and the hydrocarbon solvent is preferably in a range of 15%-35% wt., where the total amount of the asphalt and hydrocarbon solvent is 100%.

22. The cationic asphalt emulsion composition for prime coat of claim 1, which has characteristics according to standard ASTM D244

| | |
|---|---|
| Viscosity, Saybolt Furol at 25° C. SFS | 15-100 |
| Storage stability test, 24 hour, % wt | ≦5 |
| Demulsibility, 35 mL, 0.8% dioctyl sodium | ≦15 |
| Sulfosuccinate, % wt | |
| Cement mixing test, % wt | ≧10 |
| Seive test, % wt | ≦0.1 |
| Particle charge test | positive |
| Oil distillate, by volume of emulsion, % | ≧5 |
| Emulsion Distillation, residue, % wt | ≧20 |

23. The cationic asphalt emulsion composition for prime coat of claim 11, wherein 10 grams of said cationic asphalt emulsion completely penetrates through 100 grams of Portland cement type I which contains in the glass tube size 41.5±0.5 mm. in diameters in less than 3 hours.

24. The method of manufacturing the cationic asphalt emulsion for prime coat of claim 1 for batch type comprises following steps.
(a) Heating the asphalts at 110-180° C. to reduce viscosity of asphalt
(b) Filling the hydrocarbon solvent into the asphalt and mixing homogeneously to feed into the mill
(c) Preparing aqueous solvent by adding the acid into the water providing state of being acid. This is because the emulsifiers dissolve well in water having acidity state. Then, the emulsifiers are adding into a mixture of water and acid, stirring until well-dissolved.
(d) Feeding both mixtures into a mill simultaneously
wherein the obtained products from such method are the cationic asphalt emulsion composition for prime coat.

25. The method of manufacturing the cationic asphalt emulsion for prime coat of claim 1 for continuous type comprises following steps.
(a) Heating the asphalt at 110-180° C. to reduce viscosity of asphalt
(b) Feeding the hydrocarbon solvent and the asphalt into static mixer before feeding into the mill
(c) Feeding water, acid, and emulsifier via another pipeline to gather all these liquid to feed into the mill
(d) Feeding both mixtures (b) and (c) into a mill simultaneously
wherein the obtained products from such method are the cationic asphalt emulsion composition for prime coat.

26. The use of the cationic asphalt emulsion composition for prime coat of claim 1, wherein they are suitable for untreated base course and treated base course.

27. The use of the cationic asphalt emulsion composition for prime coat of claim 26, wherein the treated base course is the cement treated base or the cold in place recycling base course.

28. The use of the cationic asphalt emulsion composition for prime coat of claim 1, wherein the viscosity, Saybolt Furol at 25° C. of such asphalt emulsion, in case of the base course having low porosity is preferably 15-25 SFS.

29. The use of the cationic asphalt emulsion composition for prime coat of claim 1, wherein the viscosity, Saybolt Furol at 25° C. of such asphalt emulsion, in case of the base course having high porosity is preferably 25-50 SFS.

30. The use of the cationic asphalt emulsion composition for prime coat of claim 1, wherein the use of such asphalt emulsion sprayed on the base course has a use rate of 0.6-2.5 l/m² depending on the porosity of the base course.

31. The use of the cationic asphalt emulsion composition for prime coat of claim 1, wherein such asphalt emulsions sprayed over the temporary road to reduce airborne dust.

32. The use of the cationic asphalt emulsion composition for prime coat of claim 1, wherein such asphalt emulsions sprayed over the open space to reduce airborne dust generated by wind.

33. The use of the cationic asphalt emulsion composition for prime coat of claim 1, wherein such asphalt emulsions sprayed over ground under the buildings.

34. The use of the cationic asphalt emulsion composition for prime coat of claim 33, wherein a use rate of such cationic asphalt emulsion for prime coat is 2.0-10.0 kg/m².
